(19) United States
(12) Patent Application Publication
(10) Pub. No.: US 2009/0079708 A1
(43) Pub. Date: Mar. 26, 2009

(54) Three-wire resistive touch panel and display device using same

(75) Inventor: Yen-Hua Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/284,379

(22) Filed: Sep. 22, 2008

(30) Foreign Application Priority Data
Sep. 21, 2007 (CN) 200710077347.6

(51) Int. Cl. G06F 3/045

(52) U.S. Cl. 345/174

(57) ABSTRACT

An exemplary resistive touch panel includes a top substrate having a first conductive coating thereon, and a bottom substrate comprising a second conductive coating thereon. The first conductive coating includes a plurality of predetermined target points that are electrically connected to form a series circuit, and the series circuit has two terminals. The second conductive coating has a single terminal. A display device employing the resistive touch panel is also provided.

### FIELD OF THE DISCLOSURE

The present invention relates to a 3-wire resistive touch panel having a relatively simple structure, and a display device using the touch panel.

### BACKGROUND

Touch panels are transparent or opaque input devices for computers and other electronic systems, and are activated by contact from a user's finger, a stylus, or another device.

The dominant touch panel technologies presently in use are resistive, capacitive, infrared, and acoustic touch panels. Referring to FIG. 6, a typical display device 1 employs a resistive touch panel 10. The display device 1 includes a flat panel display (FPD) 16, and the touch panel 10 attached on a display surface 160 of the flat panel display 16 via a first adhesive 18.

The touch panel 10 includes a top substrate 11 and a bottom substrate 12. A first conductive coating 13 and a second conductive coating 14 are respectively applied on inner surfaces of the top and bottom substrates 11, 12. A second adhesive 15 is arranged at peripheral areas of the first and second conductive coatings 13, 14, thereby adhering the first and second conductive coatings 13, 14 together. A plurality of spacers 17 are also provided between the first and second conductive coatings 13, 14, thereby separating the first and second conductive coatings 13, 14 and avoiding electrical contract therebetween unless the touch panel 10 is touched.

Referring also to FIG. 7, the first conductive coating 13 includes a plurality of wavy first resistance lines 131 each arranged generally parallel to an X-axis of a rectangular Cartesian coordinate system, first and second electrode bars E1, E2 disposed at the left and right ends of the first resistance lines 131 respectively, and a pair of terminal wires X1, X2 connected to the first and second electrode bars E1, E2, respectively. The second conductive coating 14 has a structure similar to the first conductive coating 13. However, a plurality of wavy second resistance lines 141 are each arranged generally parallel to a Y-axis of the Cartesian coordinate system, third and fourth electrode bars E3, E4 are disposed at the upper and lower ends of the second resistance lines 141 respectively, and a pair of terminal wires Y1, Y2 are connected to the third and fourth electrode bars E3, E4, respectively.

In operation, a voltage difference is applied to the pair of terminal wires X1, X2, and voltage gradients are generated on the first resistance lines 131. Using the terminal wire Y1 as a grounding terminal wire, a voltage level of a point corresponding to the first resistance lines 131 where a contact occurs can be detected by the terminal wire Y1. Then an X-coordinate of the contact point can be determined by an associated analyzing circuit (not shown) according to the detected voltage level. In a similar manner, a voltage difference is applied to the pair of terminal wires Y1, Y2, a voltage level of a point corresponding to the second resistance lines 141 where the contact occurs can be detected by the terminal wire X1, and a Y-coordinate of the contact point can be determined by the analyzing circuit according to the detected voltage level.

In this kind of 4-terminal wire resistive touch panel 10, the four terminal wires X1, X2, Y1, Y2 apply voltage signals to the first and second conductive coatings 13, 14, respectively, whereby voltage signals of the contact point can be detected. However, such 4-terminal wire resistive touch panel 10 has a relatively complex driving method, and requires that the analyzing circuit have a same number of driving terminal wires corresponding to the four terminal wires X1, X2, Y1, Y2. Thus, the touch panel 10 and the corresponding analyzing circuit have complex circuit structures.

What is needed, therefore, is a touch panel that can overcome the above-described deficiencies. What is also needed is a display device employing the touch panel.

### SUMMARY

In one embodiment, a resistive touch panel includes a top substrate having a first conductive coating thereon, and a bottom substrate comprising a second conductive coating thereon. The first conductive coating includes a plurality of predetermined target points that are electrically connected to form a series circuit, and the series circuit has two terminals. The second conductive coating has a single terminal.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is a side, cross-sectional view of a display device according to an exemplary embodiment of the present invention, the display device including a touch panel, the touch panel including a first conductive coating, a second conductive coating, and an analyzing circuit (not shown).

FIG. 2 is an isometric, exploded view of the first and second conductive coatings of the touch panel of FIG. 1, showing the first and second conductive coatings being electrically connected to the analyzing circuit.

FIG. 3 is an isometric, exploded view of first and second conductive coatings of a touch panel according to an alternative embodiment of the present invention, the touch panel being similar to the touch panel of FIG. 1.

FIG. 4 illustrates use of the touch panel of FIG. 1 in one kind of dialing system.

FIG. 5 illustrates use of the alternative embodiment of the touch panel in one kind of dialing system.

FIG. 6 is a side, cross-sectional view of a conventional display device employing a resistive touch panel, the resistive touch panel including first and second conductive coatings.

FIG. 7 is an abbreviated, top plan view showing the first and second conductive coatings of the touch panel of FIG. 6.

### DETAILED DESCRIPTION OF EMBODIMENTS

Reference will now be made to the drawings to describe various embodiments of the present invention in detail.

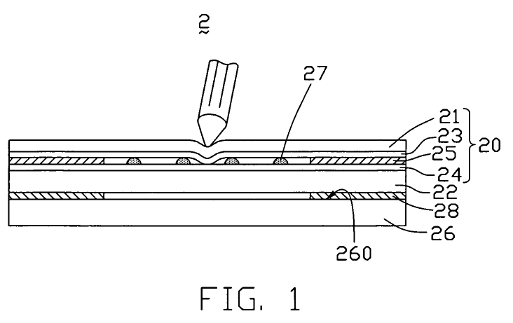

Referring to FIG. 1, a display device 2 according to an exemplary embodiment of the present invention is shown. The display device 2 includes a touch panel 20 and a flat panel display 26. The flat panel display 26, for example a liquid crystal display (LCD) or a plasma display panel (PDP), includes a display surface 260. The touch panel 20 is attached onto the display surface 260 via a sealant 28 at peripheral areas therebetween.

The touch panel 20 is a resistive touch panel, and includes a top substrate 21 and a bottom substrate 22. A first conductive coating 23 and a second conductive coating 24 are respectively applied on inner surfaces of the top and bottom substrates 21, 22. An adhesive 25 is applied at peripheral areas of the first and second conductive coatings 23, 24 to adhere the first and second conductive coatings 23, 24 together. A plurality of spacers 27 are also provided between the first and second conductive coatings 23, 24, to provide separation and avoid electrical contact therebetween unless the top substrate 21 is touched.

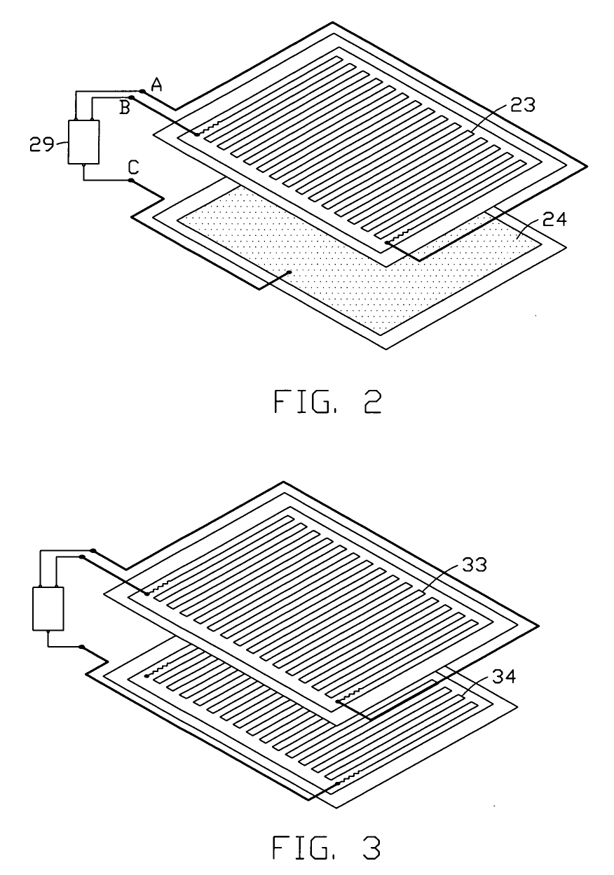

Referring also to FIG. 2, the first and second conductive coatings 23, 24 are both electrically connected to an analyzing circuit 29. The first conductive coating 23 includes a plurality of target points (not labeled) thereon. Distributions of the target points are predetermined, and correspond to desired control signals. In the illustrated embodiment, the target points are arranged in an imaginary matrix. The target points are electrically connected to form a series circuit that has a first terminal wire A and a second terminal wire B. The first terminal wire A and the second terminal wire B are both electrically connected to the analyzing circuit 29. Therefore, when the analyzing circuit applies an input voltage to the series circuit, a dividing voltage of each target point is predetermined according to the input voltage. The second conductive coating 24 is a planar resistor, and has a third terminal wire C electrically connected to the analyzing circuit 29.

In operation, the input voltage is applied to the first and second terminal wires A, B. When one of the target points is effectively contacted, portions of the first and second conductive coatings 23, 24 corresponding to the contacted target point meet. A voltage of the second conductive coating 24 changes to a contact voltage, which is equal to the dividing voltage of the contacted target point. The contact voltage of the second conductive coating 24 is read and compared to the input voltage by the analyzing circuit 29. Thus the location of the contacted target point can be determined by the analyzing circuit 29.

In the 3-wire resistive touch panel 20, only the three terminal wires A, B, C are needed to apply the input voltage to the first conductive coating 23 and read the contact voltage of the second conductive coating 24, thus locating the contacted target point. Therefore the touch panel 20 has a relatively simple driving method, and typically only requires that the analyzing circuit 29 have a same number of (i.e., three) driving terminal wires (not labeled) corresponding to the three terminal wires A, B, C. Thus, the touch panel 20 and the corresponding analyzing circuit 29 have relatively simple circuit structures.

Referring to FIG. 3, this shows first and second conductive coatings 33, 34 of a touch panel according to an alternative embodiment of the present invention, the touch panel being similar to the touch panel 20. Each of the first and second conductive coatings 33, 34 is similar to the above-described first conductive coating 23. However, the second conductive coating 34 only includes one terminal wire (not labeled).

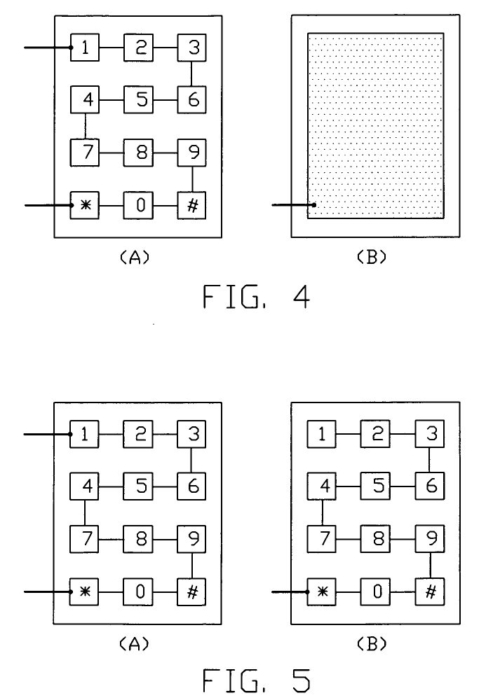

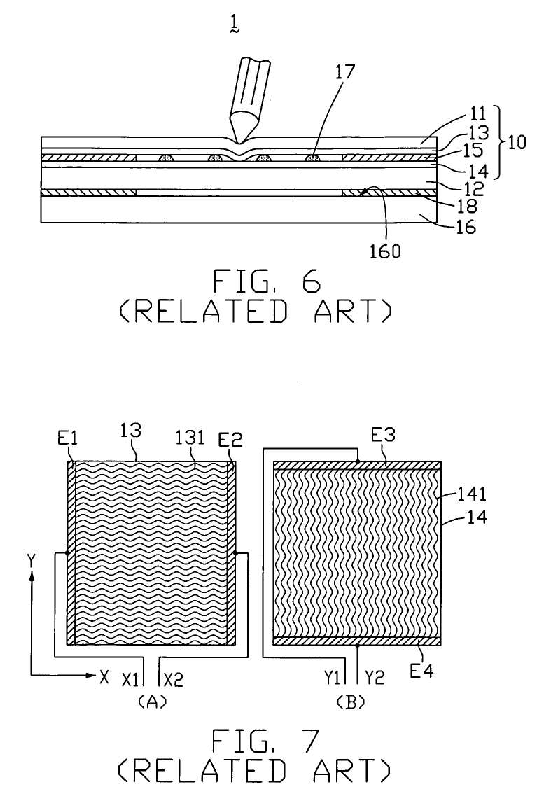

In one of numerous possible applications, the touch panel 20 can be utilized in a dialing system of a device such as a mobile phone, as shown in FIG. 4. In FIG. 4, part “(A)” shows locations of virtual keypad numbers and characters that may be displayed by a display of the mobile phone and viewed by a user. The locations of the numbers and characters correspond to a plurality of target points of the first conductive coating 23. The locations of the numbers and characters relative to a series circuit of the first conductive coating 23 are also shown in part “(A)”. Part “(B)” represents the second conductive coating 24.

In one of numerous possible applications, the touch panel of the alternative embodiment can be utilized in a dialing system of a device such as a mobile phone, as shown in FIG. 5. In FIG. 5, part “(A)” shows locations of virtual keypad numbers and characters that may be displayed by a display of the mobile phone and viewed by a user. The locations of the numbers and characters correspond to a plurality of target points of the first conductive coating 33. The locations of the numbers and characters relative to a series circuit of the first conductive coating 33 are also shown in part “(A)”. Part “(B)” shows the locations of the virtual keypad numbers and characters, which also correspond to a plurality of target points of the second conductive coating 34. The locations of the numbers and characters relative to a series circuit of the second conductive coating 34 are also shown in part “(B)”.

It is to be understood, however, that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A resistive touch panel comprising:
a top substrate comprising a first conductive coating thereon, the first conductive coating comprising a plurality of predetermined target points that are electrically connected to form a series circuit, the series circuit having two terminals; and
a bottom substrate comprising a second conductive coating thereon, the second conductive coating having a single terminal.

2. The resistive touch panel of claim 1, wherein the second conductive coating comprises a planar resistor.

3. The resistive touch panel of claim 2, further comprising an analyzing circuit electrically connected to the two terminals of the series circuit of the first conductive coating and the single terminal of the second conductive coating.

4. The resistive touch panel of claim 3, wherein the analyzing circuit is capable of applying a voltage to the series circuit, reading a contact voltage of the second conductive coating, and comparing the contact voltage to the applied voltage.

5. The resistive touch panel of claim 1, wherein the second conductive coating is substantially the same as the first conductive coating, except that the second conductive coating has only the single terminal.

6. A display device comprising:
a flat panel display; and
a resistive touch panel adjacent to the flat panel display, the resistive touch panel comprising:
a top substrate comprising a first conductive coating thereon, the first conductive coating comprising a plurality of predetermined target points that are electrically connected to form a series circuit, the series circuit having two terminals; and
a bottom substrate comprising a second conductive coating thereon, the second conductive coating having a single terminal.

7. The display device of claim 6, wherein the second conductive coating comprises a planar resistor.

8. The display device of claim 7, further comprising an analyzing circuit electrically connected to the two terminals of the series circuit of the first conductive coating and the single terminal of the second conductive coating.

9. The display device of claim 7, wherein the analyzing circuit is capable of applying a voltage to the series circuit, reading a contact voltage of the second conductive coating, and comparing the contact voltage to the applied voltage.

10. The display device of claim 6, wherein the second conductive coating is substantially the same as the first conductive coating, except that the second conductive coating has only the single terminal.
